(19) United States
(12) Patent Application Publication
(10) Pub. No.: US 2022/0342374 A1
(43) Pub. Date: Oct. 27, 2022

(54) Auto-Generated Modular Connectors For Automation Ecosystem Integration

(71) Applicant: Siemens Aktiengesellschaft, Munich (DE)

(72) Inventors: Hartmut Ludwig, West Windsor, NJ (US); Florian Ersch, Plainsboro, NJ (US); Michael Jaentsch, Princeton, NJ (US); Lingyun Wang, Princeton, NJ (US)

(21) Appl. No.: 17/763,252

(22) PCT Filed: Oct. 9, 2020
(86) PCT No.: PCT/US2020/055015

§ 371 Date: Mar. 24, 2022

Related U.S. Application Data
(60) Provisional application No. 62/913,372, filed on Oct. 10, 2019.

(51) Int. Cl. G05B 19/05

(52) U.S. Cl. CPC G05B 19/054; G05B 19/052; G05B 19/058

(57) ABSTRACT

Current approaches to integrating industrial ecosystems, for instance integrating automation functions across different vendors, lack efficiencies and capabilities. For example, system integrators are often required to develop special software that functions as a proxy or adaptor between different systems. In such cases, the proxy or adaptor is often specific to a particular set of equipment or vendors, and which can limit reusability, among other technical drawbacks. Embodiments described herein overcome one or more of the described-herein shortcomings or technical problems by providing methods, systems, and apparatuses for automatically generating connecters that enable interoperability between different ecosystems in automated industrial systems, and that define semantics that are specific to a given ecosystem. Further, such connectors can be re-used by the given ecosystem.

### CROSS-REFERENCE TO RELATED APPLICATIONS

This application claims the benefit of U.S. Provisional Application Ser. No. 62/913,372 filed on Oct. 10, 2019, the disclosure of which is incorporated herein by reference in its entirety.

### BACKGROUND

Automation systems can be used to control the operation of machines and other components in a systematic manner. Automation systems can include various automation domains such as factory automation, process automation, building automation, energy automation, and the like. Automation systems can also include equipment from multiple vendors. In some cases, equipment and machines within an automation system may use varying mechanisms associated with their respective ecosystems, such as varying runtime environments, protocols, and programming languages (e.g., vendor-specific programming languages). By way of example, automation functions are often platform specific and/or are implemented in a proprietary manner. Thus, generating an automation function that is interoperable with other automation functions can be cumbersome and time-consuming.

Automation systems typically interact with the physical world through sensors to retrieve and monitor the real world's state. Automation systems also typically interact with actuators to change and control the real world's state. In some cases, the digitalized state of physical entities is preserved in a digital twin, which can refer to a process image of the current state of a physical system. It is recognized herein, however, that standards are lacking concerning how to build and maintain digital twins. Thus, often each vendor of automation equipment establishes vendor or product specific interfaces and tools that enable automation functions to interact, via digital twins, with the real world. As a result, in some cases, system integrators and application engineers of automation systems have to deal with a vast variety of digital twins that may each provide a respective proprietary set of interfaces and tools.

Thus, it is further recognized herein that current digital twins lack capabilities and efficiencies. By way of example, shortcomings related to out-of-the-box interoperability and exchangeability among today's digital twins inhibit digitalization.

### BRIEF SUMMARY

Embodiments of the invention address and overcome one or more of the described-herein shortcomings or technical problems by providing methods, systems, and apparatuses for automatically generating connectors that define semantics specific to particular ecosystems, and that enable interoperability between different ecosystems in automated industrial systems.

In an example aspect, a method can be performed in an industrial system that comprises a plurality of ecosystems that define respective physical assets and automation equipment configured to control the physical assets. The method can include receiving an interface file that defines an interface description language. Based on the interface file, a generator or modular connector printer can generate a first integration connector that is specific to a first ecosystem of the plurality of ecosystems. The first integration connector can be used to trigger an action, from the first ecosystem, performed at a second ecosystem of the plurality of ecosystems. As an example, the action can include retrieving information from the second ecosystem, by the first ecosystem. The information can define semantics associated with the first ecosystem. The information and the semantics can be displayed on a human machine interface of the first ecosystem. Alternatively, or additionally, the action can include one or physical assets of the second ecosystem performing a task defined by the first ecosystem. Further, based on the interface file, a second integration connector can be generated that is specific to the second ecosystem. The integration connector can be plugged to the second integration connector, such that the second integration connector is also used to trigger the action performed by the second ecosystem.

In an example, the first integration connector can run on a first machine, the second integration connector can also run on the first machine, such that the first integration connector is plugged directly to the second integration connector. In another example, at runtime, a first communication connector can be inserted between the first integration connecter and the second integration connector, such that communication between the first integration connector and the second integration connector hops over a machine that hosts the first communication connector. In yet another example, at runtime, a second communication connector can be inserted between the first communication connecter and the second integration connector, such that communication between the first and second integration connectors hops over multiple machines and ecosystems. The first integration connector can also be used to trigger another action, from the first ecosystem, performed at a third ecosystem of the plurality of ecosystems.

The action can be triggered using a third integration connector that is specific to the third ecosystem.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a block diagram that illustrates an example automation system defining different ecosystems, in accordance with an example embodiment.

FIG. 2 is a block diagram that illustrates a point-to-point connection between the different ecosystems.

FIG. 3 is a block diagram that illustrates example communication connectors and integration connectors that can be generated by a connector printer and re-used for the associated ecosystem, in accordance with an example embodiment.

FIG. 4 is another block diagram that illustrates communication connecters coupled together so as to define a daisy chain between different ecosystems in accordance with an example embodiment.

FIG. 5 illustrates an example human machine interface (HMI) for using connectors to interoperate among different ecosystems in accordance with an example embodiment.

FIG. 6 shows an example of a computing environment within which embodiments of the disclosure may be implemented.

### DETAILED DESCRIPTION

Automation functions, automation equipment, and automation engineering systems and tools are often locked into vendor-specific ecosystems. For example, it is recognized herein that automation ecosystem vendors often focus on optimizing their own environment (e.g., hardware, software, runtime, engineering and development tools), such that there is often little support for integrating their environment with competitors or third party ecosystems.

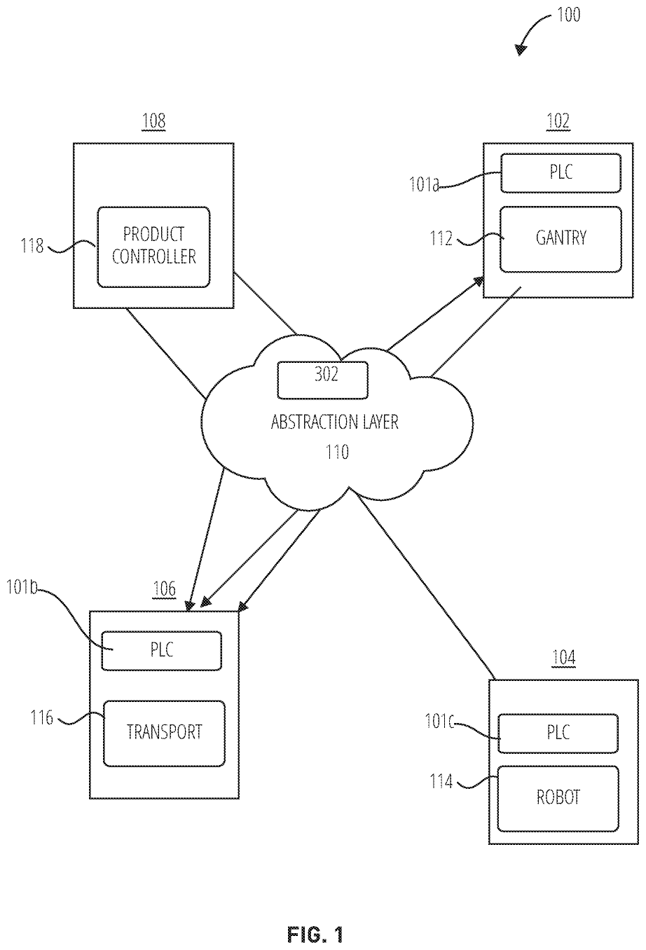

Referring to FIG. 1, an example automation system 100 defines a plurality of ecosystems or domains. In particular, the example system 100 can include a first or production ecosystem 102, a second or production ecosystem 104, a third or production ecosystem 106, and a fourth or product ecosystem 108. The example industrial system 100 can define or be part of a factory, such as a factory for manufacturing or assembling various products. In accordance with the example, the production ecosystem 102 includes a gantry station 112, the production ecosystem 104 includes a robot station 114, and the production ecosystem 106 includes a transport station 116, though it will be understood that the production ecosystems can include any stations as desired. It will further be understood that while four ecosystems of the example automation system 100 are illustrated, automation systems described herein may include any number of ecosystems, and all such systems are contemplated as being within the scope of this disclosure.

Each ecosystem can include physical assets that can be controlled by automation equipment configured to control the respective physical assets. Such automation equipment can include one or more programmable logic controllers (PLCs) 101. By way of example, the gantry station can include a gantry PLC 101a, the transport station can include a transport PLC 101b, and the robot station 114 can include a robot PLC 101c. The PLCs, and thus the automation equipment, may be specific to one or more physical assets in the respective ecosystem. The automation system 100 can be configured to perform various automation functions.

Still referring to FIG. 1, it is recognized herein that when automation functions are developed within the same ecosystem (e.g., SIMATIC), those automation functions can, in some cases, be easily integrated with each other so as to interoperate with each other. In contrast, when automation functions are developed for different ecosystems, the automation functions may be incompatible with one another, such that they do not interoperate with each other without significant integration effort. By way of example, vendors might provide some open programming (e.g., WinCC ODK) or communication interfaces (e.g., OPC-UA server) that enables other ecosystems to share and exchange (e.g., consume or provide) information across ecosystems. It is recognized herein, however, that this may require application engineers or system integrators to develop software (e.g., glue code) that maps open interfaces of one ecosystem into open interfaces of another ecosystem. It is further recognized herein that such code may be specific to a given use case, and thus is not reused. In particular, for example, development of such glue code can include integrating existing protocol stacks or developing protocol stacks; crossing of language boundaries; converting data types for a selected protocol stack (e.g., layout, versioning); adopting an execution model of a selected protocol stack (e.g., threading, data integrity, timeout); developing a state machine to manage a user-defined application protocol (e.g., connection(loss) management, notification/events); and/or using generic interfaces (e.g., read/write data) that require mapping to domain context.

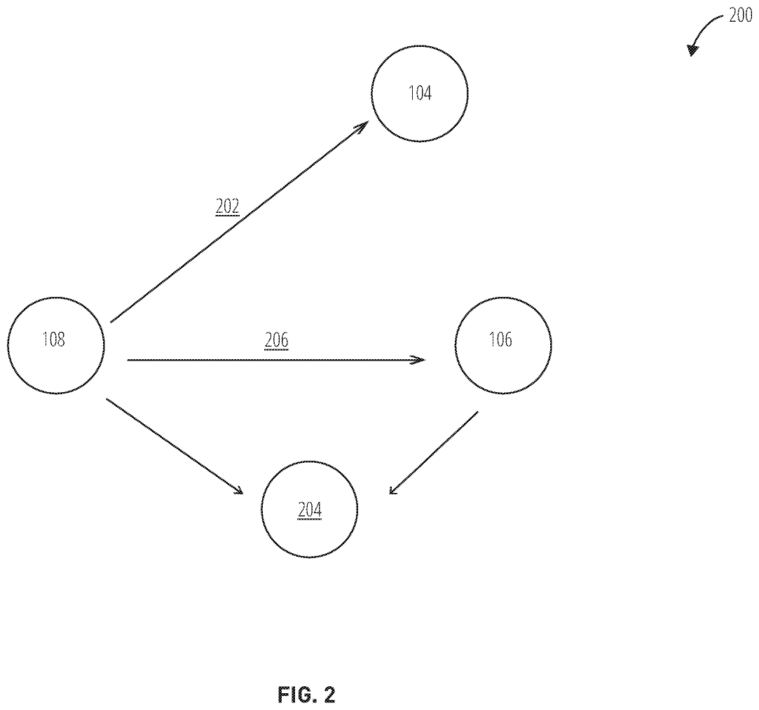

To further illustrate technical problems related to current approaches, FIG. 2 shows an example system 200 that includes the example ecosystems 104, 106, and 108. As described herein, in current approaches, automation vendors often focus on the perfection of their own first ecosystem, and add communication drivers (e.g., COM drivers in WinCC) and openness interfaces (e.g., scripting, ODK), to facilitate glue code development for integrating incompatible automation functions. Referring to FIG. 2, in the example system 200, the product ecosystem 108 can communicate with the production ecosystem 104 via a point-to-point connection 202 that has been implemented between the ecosystems 108 and 104. In other examples, ecosystems can employ standards (e.g., OPC-UA or DDS) so as to enable some integration. It is recognized herein, however, that ecosystems that do not support a given standard often cannot interoperate with an ecosystem that employs the given standard. For example, in the example system 200, the ecosystem 108 and the production ecosystem 106 each support a standard 204 that enables them to communicate with each other via a connection 206 between the ecosystems 108 and 106. In contrast, the second ecosystem 104 does not support the standard 204, and thus is not able to communicate with the third ecosystem 106.

Thus, still referring to the example system 200 of FIG, 1, in order to integrate automation functions in the different ecosystems, connectors, which can be referred to as glue code, can be developed. It is recognized herein, however, that these connectors are typically suited for point-to-point integration so as to define monolithic connectors that enable interoperability of only two ecosystems. Thus, in some cases, new connectors are developed each time an additional ecosystem is integrated within the system 200. Further, it is recognized herein that such connectors are often generic and therefore difficult to use because, for example, they do not carry semantics about the respective domain. By way of example, an generic connector might support read/write/subscribe topics, but not read/write/subscribe topics for a specific operation, such as a change in oil pressure or the like. Similarly, by way of further example, generic connectors might not support interface-oriented access (e.g., Request/Reply pattern) or topic-oriented access (publish/subscribe pattern) to another ecosystem.

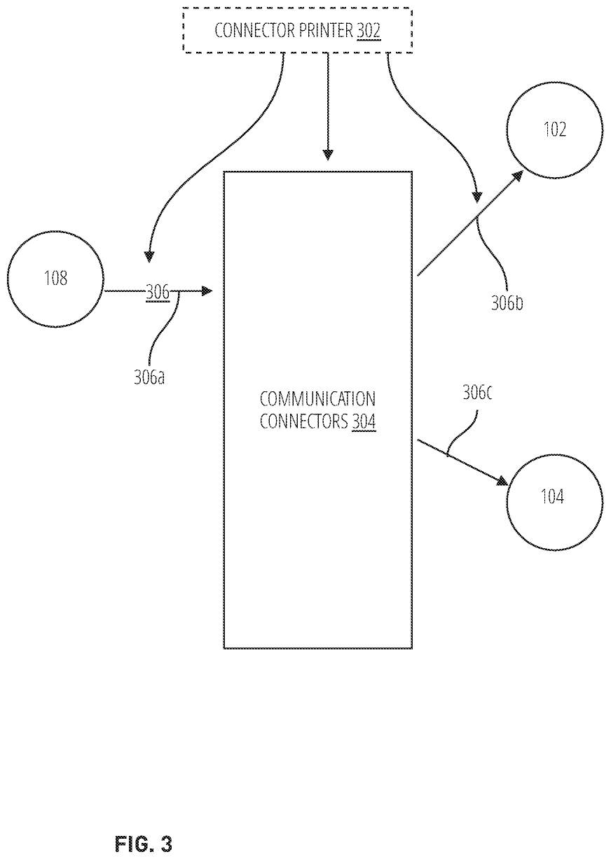

Referring now to FIG. 3, in accordance with various embodiments, a generator module or modular connector printer 302 can generate connectors as needed. Using the modular connector printer 302, automation function developers can define interfaces and/or topics with semantics and domain specifics that are user-friendly. Glue code, or a connector, can be generated and linked at runtime, which can define late binding, so as to map a definition across ecosystems. In various examples, the modular connector printer 302 can generate one or communication connectors 304 and/or one or more integration connectors 306. The communication connector 304 can provide a generic communication interface for using various existing protocol stacks, such as, for example and without limitation, HTTP, MQTT, and S7-DOS. In an example, the communication connector 304 defines a generic interface or communication abstraction that is developed once per supported protocol stack. Thus, the communication connector 304 can be used to transport information or communication from one computational node to another. In some cases, multiple communication connectors can be linked together, such that communication between two integration connecters hops over multiple machines and ecosystems. The integration connector 306 can map a natively accessible easy-to-use interface and topic having domain semantics to a generic communication interface defined by the communication connector 304. In some cases, a given integration connector 306 can be generated or pre-coded based on a user-defined interface or topic description. In an example, one integration connector 306 is generated per supported ecosystem. Thus, referring to FIG. 3, in accordance with an example, the integration connector 306 can be generated once per ecosystem, such that a first integration connector 306a can be generated for the product ecosystem 108, a second integration connector 306b can be generated for the ecosystem 102, and a third integration connector 306c can be generated for the ecosystem 104. In particular, the first integration connector 306a can be used for the ecosystem 108 to interoperate with the ecosystem 102 or the ecosystem 104, or any other ecosystem. In various examples, the communication connector 304 can be combined with any type of integration connector 306, in some cases, depending on the availability of protocol stacks for the given ecosystems. In some cases, integration connectors 306 can be directly linked with each other without the communication connector 304, for instance, when two or more integration connectors run on the same machine.

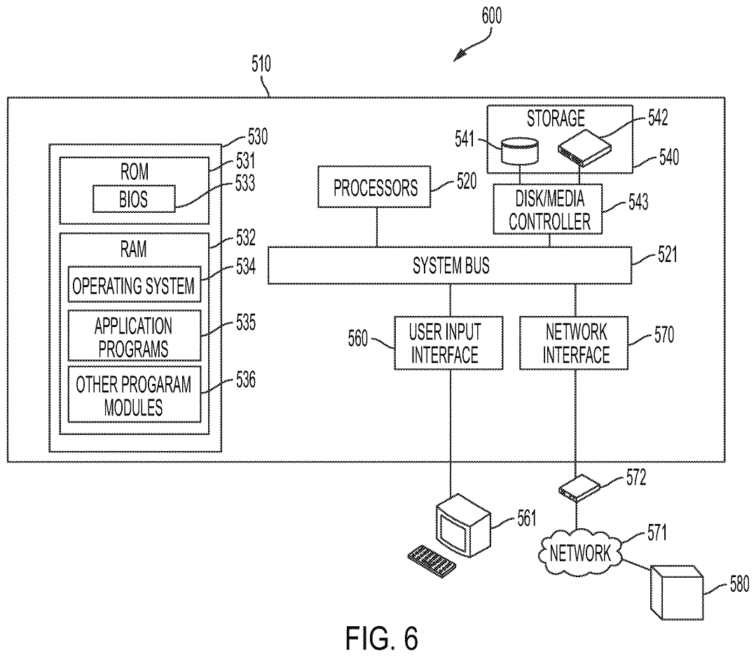

Referring also to FIG. 1, various automation systems described herein can include an abstraction layer 110 that abstracts (exposes) automation functions that can be performed by the automation equipment and the physical assets. In accordance with various embodiments, the abstraction layer 110 can include the generator module or the connector printer 302. The abstraction layer 110 can execute in a runtime environment, so as to provide interfaces to the automation functions. The abstraction layer 110, and thus the connector printer 302, can be implemented on a server, a cloud-based computing environment, a vendor-specific runtime platform environment, or other industrial computing system, such as a computer system 510 (see FIG. 6).

The abstraction layer 110 can abstract various functional characteristics, which can define automation functions, from the automation equipment. The automation functions can be soft-wired together, such that the abstraction layer 110 can serve as an intermediary between various development environments and various automation equipment. Thus, the automation system 100, in particular the abstraction layer 110, can provide functionality corresponding to a physical component, for instance the automation equipment and/or physical assets. In doing so, developers can operate in one or more development environments, for instance a development environment of their choice, to use various automation functions, via the abstraction layer 110, and the automation functions can be performed by the automation equipment and physical assets. In particular, the abstraction layer 110 can enable automation functions from different domains to interoperate with one another. The development environments may define one or more languages or platforms, such as Java, C, Matlab, Python, Siemens Totally Integrated Automation (TIA) Portal, or the like. Thus, various development environments can utilize various automation equipment from various domains, via the abstraction layer 110.

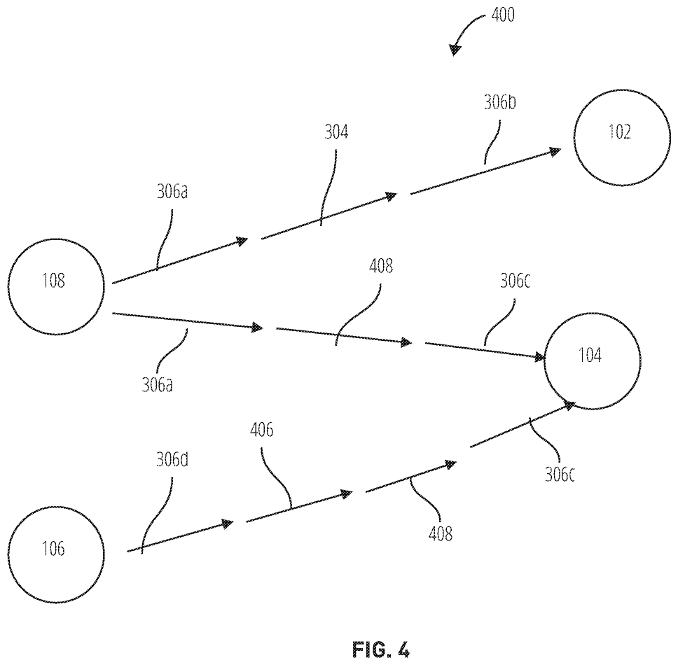

Referring also to FIG. 4, an example system 400 includes the example ecosystems 102, 104, 106, and 108, so as illustrate an example of interoperability using connectors across multiple ecosystems. As an example, the gantry station 112 can be controlled by automation equipment that is programmed in a second programming language that is different than the first programming language of the product controller 118. By way of example, the gantry PLC 101a may define one or more programmable logic controllers from Siemens (e.g., SIMATIC S7-1517) that are programmed in the second programming language (e.g., IEC61131 in a TIA Portal engineering environment). Continuing with the example, the robot station 114 can be controlled by automation equipment from Kuka, such as a Kuka robot PLC 101c that is programmed in a third programming language (e.g., Java-based) that is different than the first and second programming languages. The transport station 116 can be controlled by the transport PLC 101b, which can be from MagneMotion and provide control nodes programmed in a fourth programming language (e.g., Web or C++ based). Thus, without being bound by the specific examples, the functionality of each of the PLCs 101a-c and product controller 118 can be programmed with languages and tools supported by the equipment vendor of its respective ecosystem. Further, each of the PLCs 101a-c and the PC-based product controller 118 can each implement one or more functions that are called by one another. Thus, the various PCS 101a-c and the PC-based product controller 118 need to interact with each other, in various use cases.

In another example, the product ecosystem 108 defines a WinCC consumer of one or more automation functions. Further, in the example, the production ecosystem 102 can include a Beckhoff PLC 101a and the production ecosystem 104 can include a SIMATIC PLC 101b that each provide the same interface/topic as each other. The product ecosystem 108 can use the integration connector 306a to access the production ecosystem 102 or the production ecosystem 104. Thus, the consumer can use the same integration connector to access PCLs in different ecosystems, and the code on the consumer (e.g., within the WinCC application) can be agnostic of the particular ecosystem that provides an interface or topic. In various examples, the integration connector 306c can be used by the production ecosystem 104 regardless of whether an interface or topic is invoked by the product ecosystem 108 or the production ecosystem 106. Similarly, an integration connector 306d can be generated that is specific to the ecosystem 106. Thus, code on the provider side (e.g., SIMATIC PLC) can be agnostic of the ecosystem that uses an interface or topic. The system 400 can also include one or more communication connectors 304, for instance an HTTP communication connector 406 or an S7-DOS communication connector 408, which can be combined to map, for example, from the product ecosystem 108 to the production ecosystem 104. Alternatively, or additionally, the S7-DOS communication connector 408 can connect the integration connector 306a of the product ecosystem 108 with the integration connector 306b of the first production ecosystem 102.

With continuing reference to FIG. 4, and referring also to FIG. 1, in an example, each production ecosystem 102, 104, and 106 can offer or provide various production skills so as to perform various industrial tasks, such as for example pick and place, transport, assembly, or the like. The product ecosystem 108 can use or consume one or more of the production ecosystems 102, 104, and 106 to assemble or manufacture one or more products. Example products include various products produced in production plants having PLCs, such as, without limitation, vehicle parts (e.g., tires, doors, engine mounting), food and beverages (e.g., mixing ingredients, controlling robots for bottling plants), pharmaceutical products, or the like, though it will be understood that any product that requires machine operations can be produced in accordance with embodiments described herein, and all such products are contemplated as being within the scope of this disclosure.

in some cases, the gantry station 112, robot station 114, and transport station 116 can each be provided from different equipment vendors, which can create interoperability issues addressed herein, among other challenges. By way of example, the product ecosystem 102 can include automation equipment, for instance a product controller 118, that is associated with a product that is assembled or manufactured by the industrial automation system 100. By way of example, the product controller 118 can be PC-based, and can be programmed by a first programming language, such as WinCC for example. The product controller 118 can perform various activities during the lifecycle of a given product. For example, during a design state, a desired state of a given product can be established within the product controller 118. The desired state may refer to the overall condition of a product or machine during or after production. The desired state may indicate various information such as, for example, absolute position information, position information relative to other physical assets, temperature limitation, stress level limitations, or the like. The desired state may be determined from inputs to the product controller 118 such as, for example and without limitation, a Bill of Process (BOP), Bill of Materials (BOM), properties of the materials, and 3D models (e.g., CAD models) or other physical models of the product.

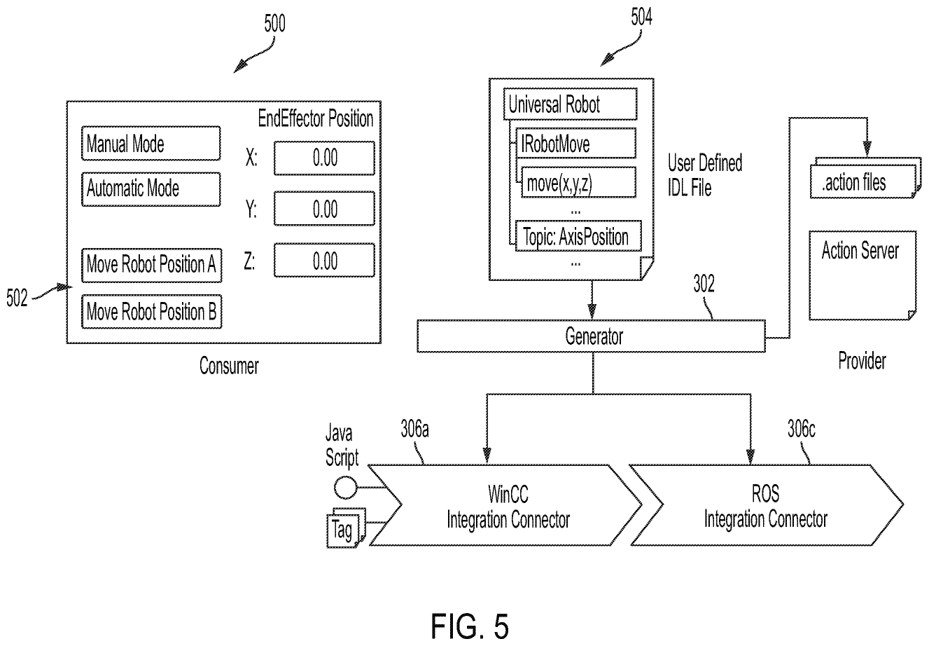

In some cases, aspects of the product may be manually defined based on user input. Referring also to FIG. 5, a system integrator may implement automation functions via a user interface, for instance via a human machine interface (HMI) 500. In an example, the robot station 114 defines an automaton function that is able to move a robot (e.g., IRobotMove), track the position of the robot, and store the position of the robot in a topic (e.g., AxisPosition). A user, for instance a system integrator, can use the robot, for instance a Universal Robot, via the WinCC application and the HMI 500. In particular, via the HMI 500, the user in the product ecosystem 108 can monitor an axis motion of the robot, and move the robot to predefined positions. Such positions can be defined at examples inputs 502 of the HMI 500. The modular connector printer 302 can receive interface definitions and topics, and can generate connectors based on the interface definitions and topics. For example, a user can define an interface description language (IDL) file 504 that includes domain semantics that define an interface (e.g., IRobotMove) and topic (e.g., AxisPosition). Based on the IDL file 504, the modular connector printer 302, which can also be referred to as a generator module, can generate integration connectors 306, in particular the WinCC integration connector 306a. The WinCC integration connector 306a can define tags, for instance an Axis Position. The WinCC integration connector can further define an application programming interface (API), such as a Java Script APT (e.g., IRobotMove (x, y, z)). The WinCC integration connector 306a can thereafter be imported into the product ecosystem 108, such that the related tags and API are viewable in the HMI 500. Thus, the modular connector printer 302 can generate interfaces and topics that are easy to use and that include semantics that are specific to the given domain.

Referring to FIG. 5, in an example, a user of the product ecosystem 108 can subscribe to the production ecosystem 104, via the WinCC integration connector 306a, without manually controlling the PLC 101c of the production ecosystem 104. In particular, for example, the product ecosystem 108 subscribe to a topic of the production ecosystem 104, such that the topic publishes when an associated value changes. In various embodiments, the subscriber (e.g., product ecosystem) can subscribe to the topic without knowledge of where the topic is published. Further, the integration connectors 306 can be generated based on a user-defined file, for example, that includes Java script or the like. When the communication link is formed, the communication connector 304 can be inserted between the integration connectors 304 such that the communication connector 304 can be inserted at runtime. A given integration connector 306 can be generated for any ecosystem that defines an open interface. Thus, integration connectors can be generated for target products (e.g., a PLC manufactured by a different vendor) in different ecosystems without changing firmware or otherwise adjusting the target product.

Still referring generally to FIG. 5, a user, for instance an automation function developer, can define interfaces and topics in the IDL file 504. In an example, based on the definitions in the IDL file 504, the connector printer 302 can generate various integration connectors 306. Thus, in some cases, connectors between ecosystems are generated without having to develop glue code. Such integration connectors can include interfaces and topics that define semantics that are specific to the associated domain, such that automation function developers can focus on business logic development, rather than interoperability. In particular, for example, automation functions can be developed in the language and/or environment of choice. Further, as shown in the example system 400, communication connectors can be combined and linked so as define communication links that hop over multiple physical systems, for example, based on the availability of communication protocols on each node. Thus, in accordance with various embodiments, connectors can be applied in various patterns as an add-on to any ecosystems based on existing interfaces. Further, such connector modularization can enable the integration connectors to be re-used across a range of communication connectors.

Thus, as described herein, in an example aspect, a method can be performed in an industrial system that comprises a plurality of ecosystems that define respective physical assets and automation equipment configured to control the physical assets. The method can include receiving an interface file that defines an interface description language. Based on the interface file, a generator or modular connector printer can generate a first integration connector that is specific to a first ecosystem of the plurality of ecosystems. The first integration connector can be used to trigger an action, from the first ecosystem, performed at a second ecosystem of the plurality of ecosystems. As an example, the action can include retrieving information from the second ecosystem, by the first ecosystem. The information can define semantics associated with the first ecosystem. The information and the semantics can be displayed on a human machine interface of the first ecosystem. Alternatively, or additionally, the action can include one or physical assets of the second ecosystem performing a task defined by the first ecosystem. Further, based on the interface file, a second integration connector can be generated that is specific to the second ecosystem. The integration connector can be plugged to the second integration connector, such that the second integration connector is also used to trigger the action performed by the second ecosystem.

As further described herein, in an example, the first integration connector can run on a first machine, the second integration connector can also run on the first machine, such that the first integration connector is plugged directly to the second integration connector. In another example, at runtime, a first communication connector can be inserted between the first integration connecter and the second integration connector, such that communication between the first integration connector and the second integration connector hops over a machine that hosts the first communication connector. In yet another example, at runtime, a second communication connector can be inserted between the first communication connecter and the second integration connector, such that communication between the first and second integration connectors hops over multiple machines and ecosystems. The first integration connector can also be used to trigger another action, from the first ecosystem, performed at a third ecosystem of the plurality of ecosystems. The action can be triggered using a third integration connector that is specific to the third ecosystem.

FIG. 6 illustrates an example of a computing environment within which embodiments of the present disclosure may be implemented. A computing environment 600 includes a computer system 510 that may include a communication mechanism such as a system bus 521 or other communication mechanism for communicating information within the computer system 510. The computer system 510 further includes one or more processors 520 coupled with the system bus 521 for processing the information. The robot device 104 may include, or be coupled to, the one or more processors 520.

The processors 520 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 520 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 521 may include at least one of a system bus, a memory bus, an address bus, or a message bus, and may permit exchange of information (e.g., data (including computer-executable code), signaling, etc.) between various components of the computer system 510. The system bus 521 may include, without limitation, a memory bus or a memory controller, a peripheral bus, an accelerated graphics port, and so forth. The system bus 521 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 6, the computer system 510 may also include a system memory 530 coupled to the system bus 521 for storing information and instructions to be executed by processors 520. The system memory 530 may include computer readable storage media in the form of volatile and/or nonvolatile memory, such as read only memory (ROM) 531 and/or random access memory (RAM) 532. The RAM 532 may include other dynamic storage device(s) (e.g., dynamic RAM, static RAM, and synchronous DRAM). The ROM 531 may include other static storage device(s) (e.g., programmable ROM, erasable PROM, and electrically erasable PROM). In addition, the system memory 530 may be used for storing temporary variables or other intermediate information during the execution of instructions by the processors 520. A basic input/output system 533 (BIOS) containing the basic routines that help to transfer information between elements within computer system 510, such as during start-up, may be stored in the ROM 531. RAM 532 may contain data and/or program modules that are immediately accessible to and/or presently being operated on by the processors 520. System memory 530 may additionally include, for example, operating system 534, application programs 535, and other program modules 536. Application programs 535 may also include a user portal for development of the application program, allowing input parameters to be entered and modified as necessary.

The operating system 534 may be loaded into the memory 530 and may provide an interface between other application software executing on the computer system 510 and hardware resources of the computer system 510. More specifically, the operating system 534 may include a set of computer-executable instructions for managing hardware resources of the computer system 510 and for providing common services to other application programs (e.g., managing memory allocation among various application programs). In certain example embodiments, the operating system 534 may control execution of one or more of the program modules depicted as being stored in the data storage 540. The operating system 534 may include any operating system now known or which may be developed in the future including, but not limited to, any server operating system, any mainframe operating system, or any other proprietary or non-proprietary operating system.

The computer system 510 may also include a disk/media controller 543 coupled to the system bus 521 to control one or more storage devices for storing information and instructions, such as a magnetic hard disk 541 and/or a removable media drive 542 (e.g., floppy disk drive, compact disc drive, tape drive, flash drive, and/or solid state drive). Storage devices 540 may be added to the computer system 510 using an appropriate device interface (e.g., a small computer system interface (SCSI), integrated device electronics (IDE), Universal Serial Bus (USB), or FireWire), Storage devices 541, 542 may be external to the computer system 510.

The computer system 510 may also include a field device interface 565 coupled to the system bus 521 to control a field device 566, such as a device used in a production line. The computer system 510 may include a user input interface or GUI 561, which may comprise one or more input devices, such as a keyboard, touchscreen, tablet and/or a pointing device, for interacting with a computer user and providing information to the processors 520.

The computer system 510 may perform a portion or all of the processing steps of embodiments of the invention in response to the processors 520 executing one or more sequences of one or more instructions contained in a memory, such as the system memory 530. Such instructions may be read into the system memory 530 from another computer readable medium of storage 540, such as the magnetic hard disk 541 or the removable media drive 542. The magnetic hard disk 541 and/or removable media drive 542 may contain one or more data stores and data files used by embodiments of the present disclosure. The data store 540 may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, skill data, sensor data, or any other data generated in accordance with the embodiments of the disclosure. Data store contents and data files may be encrypted to improve security. The processors 520 may also be employed in a multi-processing arrangement to execute the one or more sequences of instructions contained in system memory 530. In alternative embodiments, hard-wired circuitry may be used in place of or in combination with software instructions. Thus, embodiments are not limited to any specific combination of hardware circuitry and software.

As stated above, the computer system 510 may include at least one computer readable medium or memory for holding instructions programmed according to embodiments of the invention and for containing data structures, tables, records, or other data described herein. The term “computer readable medium” as used herein refers to any medium that participates in providing instructions to the processors 520 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 541 or removable media drive 542. Non-limiting examples of volatile media include dynamic memory, such as system memory 530. Non-limiting examples of transmission media include coaxial cables, copper wire, and fiber optics, including the wires that make up the system bus 521. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 600 may further include the computer system 510 operating in a networked environment using logical connections to one or more remote computers, such as remote computing device 580. The network interface 570 may enable communication, for example, with other remote devices 580 or systems and/or the storage devices 541, .542 via the network 571. Remote computing device 580 may be a personal computer (laptop or desktop), a mobile device, a server, a router, a network PC, a peer device or other common network node, and typically includes many or all of the elements described above relative to computer system 510. When used in a networking environment, computer system 510 may include modem 672 for establishing communications over a network 571, such as the Internet. Modern 672 may be connected to system bus 521 via user network interface 570, or via another appropriate mechanism.

Network 571 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 510 and other computers (e.g., remote computing device 580). The network 571 may be wired, wireless or a combination thereof. Wired connections may be implemented using Ethernet. Universal Serial Bus (USB), RJ-6, or any other wired connection generally known in the art. Wireless connections may be implemented using WiMAX, and Bluetooth, infrared, cellular networks, satellite or any other wireless connection methodology generally known in the art. Additionally, several networks may work alone or in communication with each other to facilitate communication in the network 571.

It should be appreciated that the program modules, applications, computer-executable instructions, code, or the like depicted in FIG. 6 as being stored in the system memory 530 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 510, the remote device 580, and/or hosted on other computing device(s) accessible via one or more of the network(s) 571, may be provided to support functionality provided by the program modules, applications, or computer-executable code depicted in FIG. 6 and/or additional or alternate functionality. Further, functionality may be modularized differently such that processing described as being supported collectively by the collection of program modules depicted in FIG. 6 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 6 may be implemented, at least partially, in hardware and/or firmware across any number of devices.

It should further be appreciated that the computer system 510 may include alternate and/or additional hardware, software, or firmware components beyond those described or depicted without departing from the scope of the disclosure. More particularly, it should be appreciated that software, firmware, or hardware components depicted as forming part of the computer system 510 are merely illustrative and that some components may not be present or additional components may be provided in various embodiments. While various illustrative program modules have been depicted and described as software modules stored in system memory 530, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method performed in an industrial system that comprises a plurality of ecosystems that define respective physical assets and automation equipment configured to control the physical assets, the method comprising:
receiving an interface file that defines an interface description language;
based on the interface file, generating a first integration connector that is specific to a first ecosystem of the plurality of ecosystems; and
using the first integration connector to trigger an action, from the first ecosystem, performed at a second ecosystem of the plurality of ecosystems.

2. The method of claim 1, wherein the action comprises retrieving information from the second ecosystem by the first ecosystem, the information defining semantics associated with the first ecosystem.

3. The method of claim 1, wherein the action comprises one or more physical assets of the second ecosystem performing a task defined by the first ecosystem.

4. The method of claim 1, the method further comprising:
based on the interface file, generating a second integration connector that is specific to the second ecosystem.

5. The method of claim 4, the method further comprising:
plugging the first integration connector to the second integration connector, so as to also use the second integration connector to trigger the action performed by the second ecosystem.

6. The method of claim 5, the method further comprising:
running the first integration connector on a first machine and also running the second integration connector on the first machine, so as to plug the first integration connector directly to the second integration connector.

7. The method of claim 5, the method further comprising:
at runtime, inserting a first communication connector between the first integration connecter and the second integration connector, such that communication between the first integration connector and the second integration connector hops over a machine that hosts the first communication connector.

8. The method of claim 7, the method further comprising:
at runtime, inserting a second communication connector between the first communication connecter and the second integration connector, such that communication between the first and second integration connectors hops over multiple machines and ecosystems.

9. The method of claim 1, the method further comprising:
using the first integration connector to trigger another action, from the first ecosystem, performed at a third ecosystem of the plurality of ecosystems, the action triggered using a third integration connector that is specific to the third ecosystem.

10. The method of claim 2, the method further comprising:
displaying the information and the semantics on a human machine interface of the first ecosystem.

11. An industrial computing system, the computing system comprising:
a processor; and
a memory storing instructions that, when executed by the processor, configure the system to:
receive an interface file that defines an interface description language;
based on the interface file, generate a first integration connector that is specific to a first ecosystem of the plurality of ecosystems; and
use the first integration connector to trigger an action, from the first ecosystem, performed at a second ecosystem of the plurality of ecosystems.

12. The system of claim 11, wherein the action comprises retrieving information from the second ecosystem by the first ecosystem, the information defining semantics associated with the first ecosystem.

13. The system of claim 11, wherein the action comprises one or more physical assets of the second ecosystem performing a task defined by the first ecosystem.

14. The system of claim 11, the memory further storing instructions that, when executed by the processor, further configure the system to:
based on the interface file, generate a second integration connector that is specific to the second ecosystem.

15. The system of claim 14, the memory further storing instructions that, when executed by the processor, further configure the system to:
plug the first integration connector to the second integration connector, so as to also use the second integration connector to trigger the action performed by the second ecosystem.

16. The system of claim 15, the memory further storing instructions that, when executed by the processor, further configure the system to:
run the first integration connector on a first machine and also run the second integration connector on the first machine, so as to plug the first integration connector directly to the second integration connector.

17. The system of claim 15, the memory further storing instructions that, when executed by the processor, further configure the system to:
at runtime, insert a first communication connector between the first integration connecter and the second integration connector, such that communication between the first integration connector and the second integration connector hops over a machine that hosts the first communication connector.

18. The system of claim 17, the memory further storing instructions that, when executed by the processor, further configure the system to:
at runtime, insert a second communication connector between the first communication connecter and the second integration connector, such that communication between the first and second integration connectors hops over multiple machines and ecosystems.

19. The system of claim 11, the memory further storing instructions that, when executed by the processor, further configure the system to:
use the first integration connector to trigger another action, from the first ecosystem, performed at a third ecosystem of the plurality of ecosystems, the action triggered using a third integration connector that is specific to the third ecosystem.

20. The system of claim 12, the memory further storing instructions that, when executed by the processor, further configure the system to:
display the information and the semantics on a human machine interface of the first ecosystem.
